(19) United States
(12) Patent Application Publication
(10) Pub. No.: US 2012/0293555 A1
(43) Pub. Date: Nov. 22, 2012

(54) INFORMATION-PROCESSING DEVICE, METHOD THEREOF AND DISPLAY DEVICE

(76) Inventor: Akihiro OKANO, Tokyo (JP)

(21) Appl. No.: 13/521,265

(22) PCT Filed: Jan. 15, 2010
(86) PCT No.: PCT/JP2010/000187

§ 371 Date: Jul. 10, 2012

(51) Int. Cl. G09G 5/08; G09G 5/00

(52) U.S. Cl. 345/660; 345/158

(57) ABSTRACT

An electronic blackboard device calculates a pointed position and a side shape of a pointer on a display surface based on a state of receiving reflected light from the pointer at first and second infrared cameras. Subsequently, a pointed position image obtained by taking an image of the pointed position from an entirety of the display surface is acquired and a color of the pointer is recognized by processing the pointed position image. Then, a drawn image of a color corresponding to the pointed position, side shape and color of the pointer is displayed and only the drawn image of a predetermined color is displayed upon a drawn image designation request while displaying the drawn image.

### TECHNICAL FIELD

The present invention relates to an information processing device and an information processing method.

### BACKGROUND ART

A display device that, when a display surface thereof is pointed by a pointer such as a finger and a stick, performs a processing corresponding to the pointed position has been known (see, for instance, Patent Literature 1).

The display device disclosed in Patent Literature 1 takes an image of a pointer stick used by a user for pointing a point using color CCD cameras provided at three of the four corners of a display surface. Then, the (horizontally elongated) rectangular image thus taken is scanned from the left to the right to extract a partial image that can be identified as the color of the pointer stick. Subsequently, a distance ratio is calculated based on a ratio of the number of pixels positioned on the right and left of the pixels of the pointer stick to identify the position of the pointer stick.

### CITATION LIST(S)

### Patent Literature

[Patent Literature 1] JP-A-2000-112616

### SUMMARY OF THE INVENTION

### Problem(s) to be Solved by the Invention

Typical application of the arrangement of Patent Literature 1 includes a so-called electronic blackboard device that displays on a display surface thereof a line of a color associated with the color of the pointer stick. However, when lines (e.g. drawn image such as a character) of a plurality of colors are displayed, a character written by a predetermined user may not be easily recognized.

An object of the invention is to provide an information processing device and an information processing method in which a predetermined drawn image can be easily recognized.

### Means for Solving the Problem(s)

An information processing device according to an aspect of the invention performs, when a predetermined position on a display surface of a display is pointed by a pointer, a processing corresponding to a pointed position, the information processing device including: a pointer identifier that identifies a first pointer and a second pointer; a pointed position identifier that identifies a first pointed position pointed by the first pointer and a second pointed position pointed by the second pointer; and a processing executor that displays a first drawn image corresponding to the first pointed position and a second drawn image corresponding to the second pointed position on the display in a manner respectively corresponding to the first pointed position and the second pointed position and performs a processing corresponding to the pointer, the pointed position by the pointer and a processing execution request, in which the processing executor displays the first drawn image and does not display the second drawn image on the display in accordance with the processing execution request requesting that the first drawn image is displayed and the second drawn image is not displayed.

An information processing device according to another aspect of the invention performs, when a predetermined position on a display surface of a display is pointed by a pointer, a processing corresponding to a pointed position, the information processing device including: a pointed position identifier that identifies the pointed position by the pointer based on a reflection state of a wireless medium emitted toward the pointer, a time required for the wireless medium to return after being reflected by the pointer or a contact state between the pointer and the display surface; a pointer identifier that acquires a pointed position image in which at least the pointed position is taken from an area corresponding to an entirety of the display surface and identifies the pointer by at least one of a color, a shape and a size of the pointer; and a processing executor that performs a processing corresponding to the pointer, the pointed position by the pointer and a processing execution request, in which the processing executor displays the first drawn image and does not display the second drawn image on the display in accordance with the processing execution request requesting that the first drawn image is displayed and the second drawn image is not displayed.

An information processing method according to still another aspect of the invention is a method in which, when a predetermined position on a display surface of a display is pointed by a pointer, a processing corresponding to a pointed position is performed, the information processing method being performed by a computing unit and including: identifying a pointed position by the pointer based on a reflection state of a wireless medium emitted toward the pointer, a time required for the wireless medium to return after being reflected by the pointer or a contact state between the pointer and the display surface; acquiring a pointed position image in which at least the pointed position is taken from an area corresponding to an entirety of the display surface; identifying a first pointer and a second pointer by processing the pointed position image and based on at least one of a color, a shape and a size of the pointer; and performing a processing corresponding to the pointer, the pointed position by the pointer and a processing execution request, where in the performing, in accordance with the processing execution request requesting that a drawn image corresponding to a movement of the first pointer is displayed and a drawn image corresponding to a movement of the second pointer is not displayed, the first drawn image is displayed on the display and the second drawn image is not displayed on the display.

### BRIEF DESCRIPTION OF DRAWINGS

FIG. 1 is a perspective view showing an electronic blackboard device according to a first exemplary embodiment of the invention.

FIG. 2 is a block diagram showing an overall structure of a relevant part of the electronic blackboard device according to the first exemplary embodiment and a second exemplary embodiment of the invention.

FIG. 3 schematically illustrates a relationship between a pointed position image and a display surface entire image in which a red pen is displayed according to the first exemplary embodiment.

FIG. 4 schematically illustrates a relationship between the pointed position image and the display surface entire image in which a finger is displayed according to the first exemplary embodiment.

FIG. 5 schematically illustrates a relationship between the pointed position image and the display surface entire image in which a palm is displayed according to the first exemplary embodiment.

FIG. 6 schematically illustrates pointer-associated processing information according to the first exemplary embodiment.

FIG. 7 is a flowchart showing a display processing of the electronic blackboard device according to the first exemplary embodiment.

FIG. 8 is a flowchart showing a pointer recognition processing in the display processing according to the first exemplary embodiment.

FIG. 9 schematically illustrates a display state after writing completion according to the second exemplary embodiment.

FIG. 10 schematically illustrates an enlarged display state of one drawn image according to the second exemplary embodiment.

FIG. 11 schematically illustrates an enlarged display state of two drawn images according to the second exemplary embodiment.

FIG. 12 schematically illustrates a display state of a model answer according to the second exemplary embodiment.

FIG. 13 is a block diagram showing an overall structure of a relevant part of an electronic blackboard device according to a third and fourth exemplary embodiments of the invention.

FIG. 14 schematically illustrates a display state after a problem is written on a vertical display according to the third exemplary embodiment.

FIG. 15 schematically illustrates a display state after an idea is written on a display according to the third exemplary embodiment.

FIG. 16 schematically illustrates a display state of a display according to the third exemplary embodiment when an idea of a fourth student is displayed on a display area of a first student.

FIG. 17 schematically illustrates a display state when ideas of the first to fourth students are displayed on the vertical display according to the third exemplary embodiment.

FIG. 18 schematically illustrates a display state during writing on a display according to the fourth exemplary embodiment.

FIG. 19 schematically illustrates a display state during writing on a vertical display according to the fourth exemplary embodiment.

### DESCRIPTION OF EMBODIMENT(S)

An electronic blackboard device as a display according to the invention will be described below.

It should be understood that, though electronic blackboard devices used for a lesson in a school or a conference in a company will be exemplarily described in the following description, the display according to the invention may be used for applications other than the above.

### First Exemplary Embodiment

Initially, an arrangement of an electronic blackboard device according to a first exemplary embodiment of the invention will be described below with reference to the attached drawings.

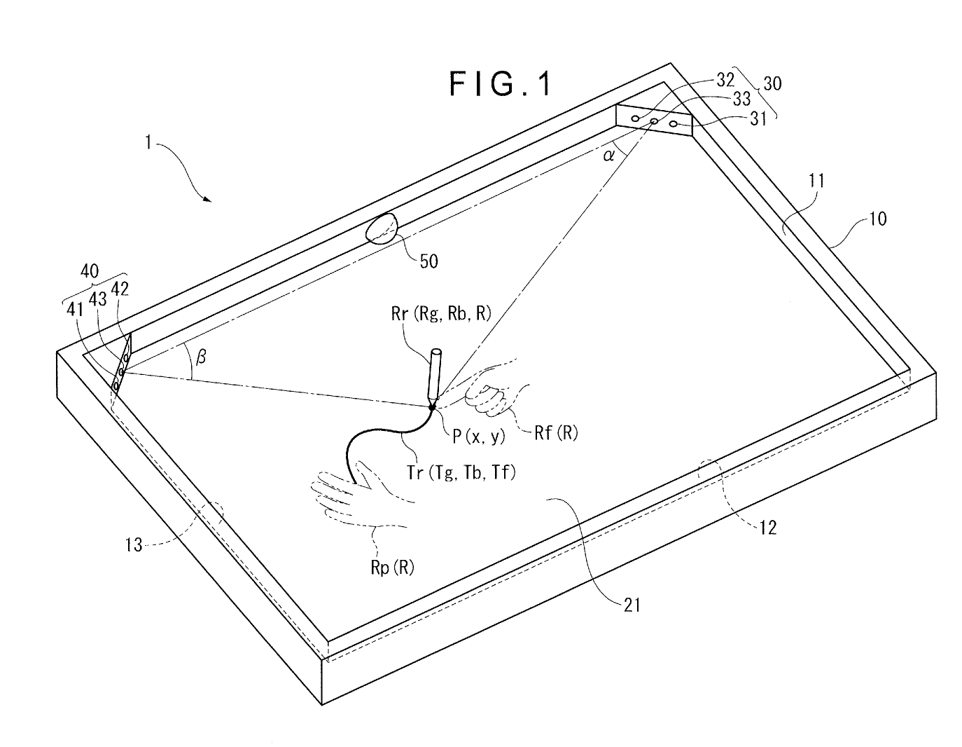

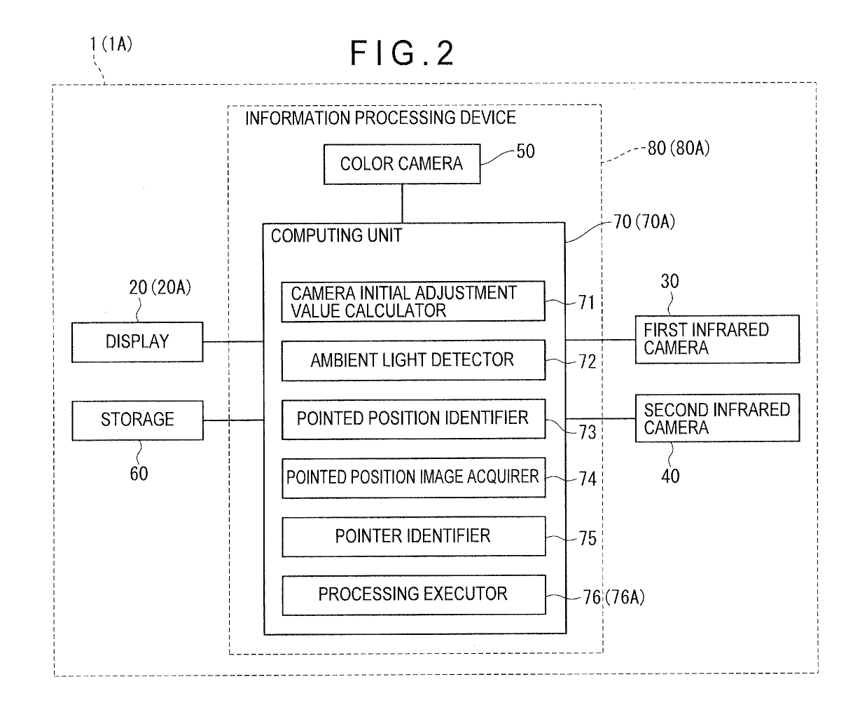

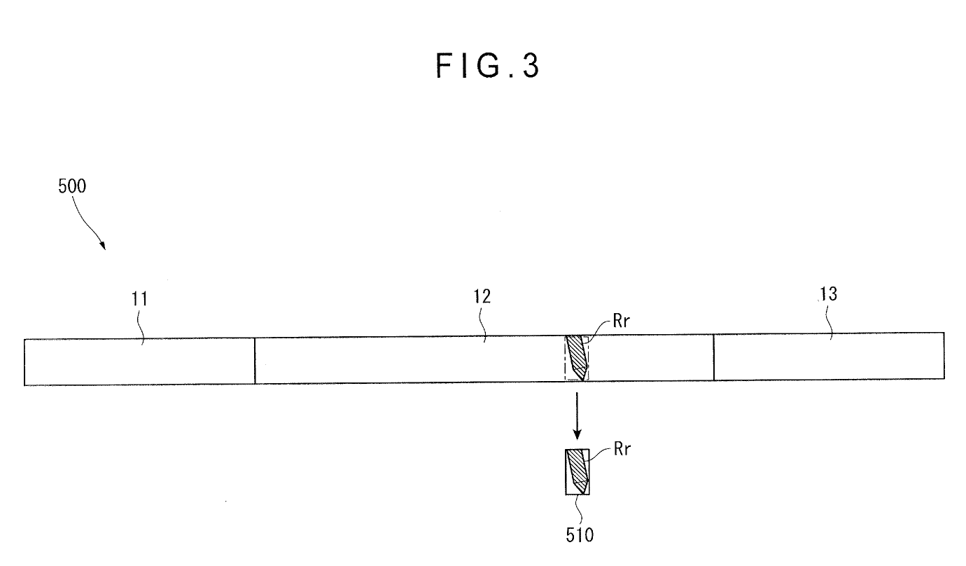

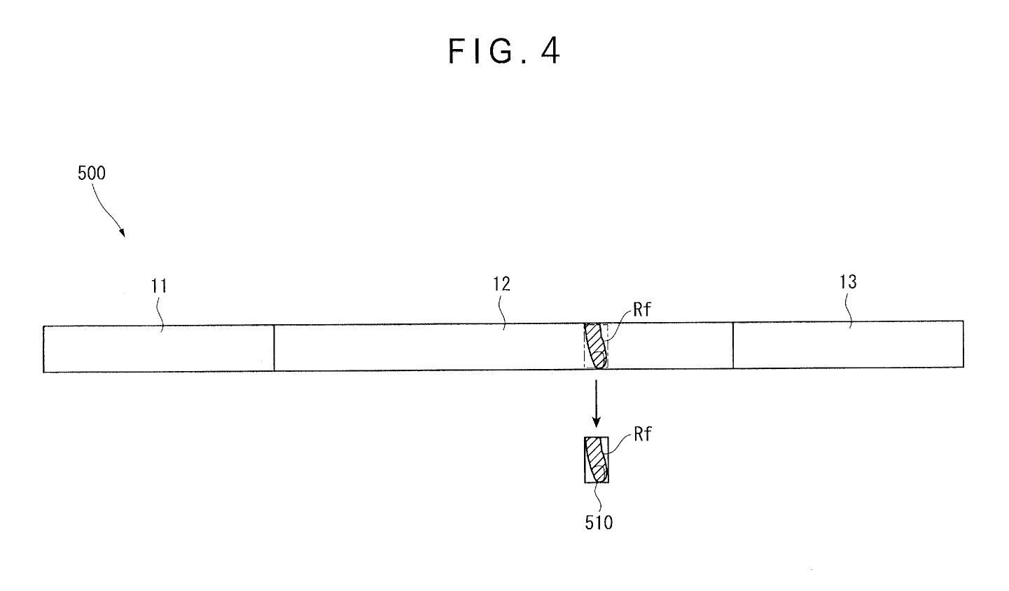

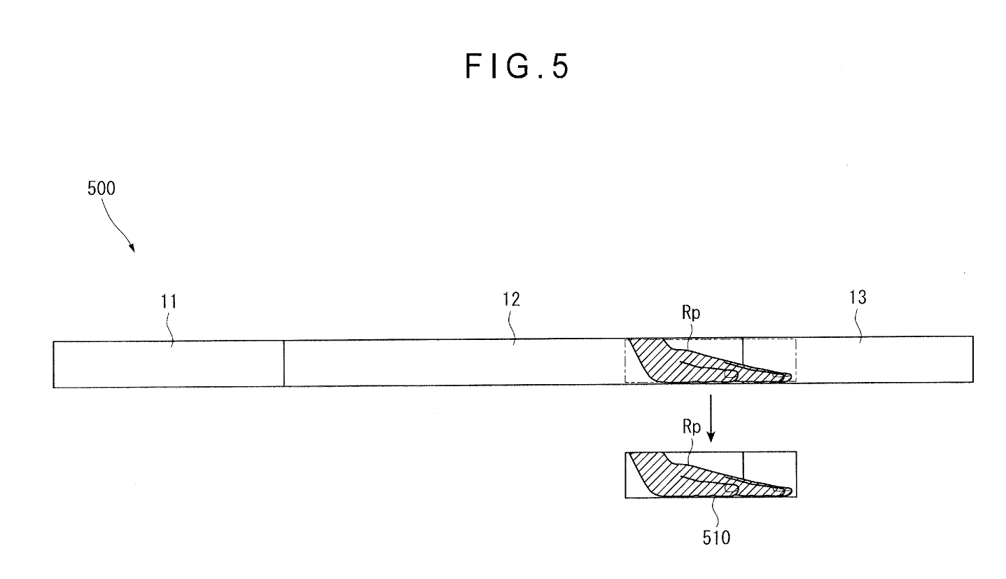

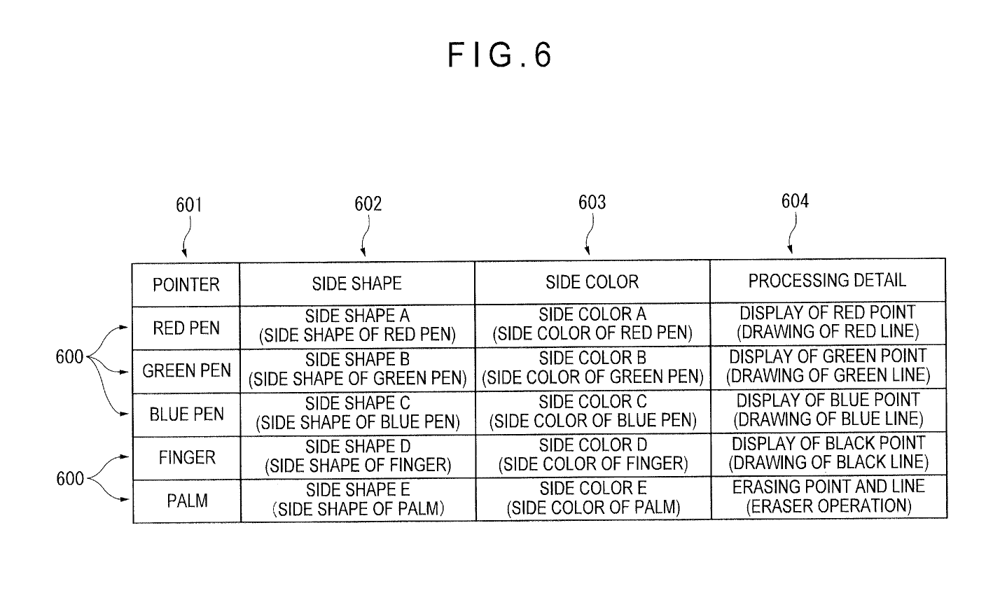

FIG. 1 is a perspective view of the electronic blackboard device. FIG. 2 is a block diagram showing an overall structure of a relevant part of the electronic blackboard device. FIG. 3 schematically illustrates a relationship between a pointed position image and a display surface entire image in which a red pen is displayed. FIG. 4 schematically illustrates a relationship between the pointed position image and the display surface entire image in which a finger is displayed. FIG. 5 schematically illustrates a relationship between the pointed position image and the display surface entire image in which a palm is displayed. FIG. 6 schematically illustrates pointer-associated processing information.

It should be understood that upper, lower, right, left and front sides (in the drawing) in FIG. 1 will be respectively referred to as “depth”, “front”, “right”, “left” and “upper” sides.

### Arrangement of Electronic Blackboard Device

An electronic blackboard device (display device) 1 shown in FIG. 1 performs a processing in accordance with an object (referred to as a pointer hereinafter) located on a display surface 21. Specifically, when a red pen Rr, a green pen Rg, a blue pen Rb or a finger Rf moves while pointing on the display surface 21, the electronic blackboard device 1 displays a red, green, blue or black line (drawn image Tr, Tg, Tb or Tf) at a position corresponding to the locus of the movement. When a palm Rp moves on the display surface 21, the drawn images Tr, Tg, Tb and Tf in a region corresponding to the locus of the movement is no more displayed (eraser operation).

The red pen Rr, green pen Rg and blue pen Rb are objects of a substantially stick shape and having end(s) of which at least surface is respectively colored in red, green and blue. The shape (profile and shape) and color of the objects are similar to those of a red, green or blue pen. The finger Rf and the palm Rp refer to a finger and a palm of a human being or an object that has a shape and color similar to those of the finger or palm. Further, the term “point(ing)” in this exemplary embodiment refers to a state in which the pointer and the display surface 21 are in contact with or brought close to each other.

Incidentally, at least one of the red pen Rr, green pen Rg, blue pen Rb, finger Rf and palm Rp will be sometimes exemplarily referred to as a target pointer R hereinafter.

On the other hand, even when an object (referred to as a non-target pointer) having a shape and/or color that is clearly different from those of the target pointer R such as a necktie and ruler points on the display surface 21, the electronic blackboard device 1 does not perform any processing.

The electronic blackboard device 1 has a substantially rectangular box-shaped body 10 with an upper surface thereof being opened. The body 10 has a leg (not shown) for installing the electronic blackboard device 1 for allowing a user to look down upon the upper surface of the body 10. As shown in FIG. 2, the body 10 is provided with a display 20, first and second infrared cameras 30 and 40, a color camera (entire display surface imaging unit) 50, a storage 60 and a computing unit 70. The color camera 50 and the computing unit 70 constitute an information processing device 80.

The display 20 is exemplarily provided by a liquid crystal panel, organic EL (Electro Luminescence) panel, PDP (Plasma Display Panel), CRT (Cathode-Ray Tube), FED (Field Emission Display) and electrophoretic display panel. As shown in FIG. 1, the display 20 includes the display surface 21 of a substantially rectangular shape that is provided to close the upper surface of the body 10. In other words, the display 20 is provided so that the display surface 21 is horizontally situated.

The first and second infrared cameras 30 and 40 are each provided at an intersection of both ends of a depth side (i.e. a side on the depth side) and right and left sides on an upper portion of the body 10. The first infrared camera 30 includes: a first light radiator 31 provided on the right side near the depth side; a second light radiator 32 provided on the right of the depth side; and a first light receiver 33 provided between the first and the second light radiator 31 and 32. The first and second light radiators 31 and 32 emits light under the control of the computing unit 70 to irradiate infrared rays on the entire display surface 21. The first light receiver 33 receives the infrared rays emitted by the first and second light radiators 31 and 32 and reflected by the pointer (i.e. reflected light) and sends a signal indicating a light-receiving state to the computing unit 70.

The second infrared camera 40 includes third and fourth light radiators 41 and 42 and a second light receiver 43 that respectively function in a manner similar to the first and second light radiators 31 and 32 and the first light receiver 33.

The color camera 50 is provided approximately at the center in the right-left direction of the depth side in the upper portion of the body 10. The color camera 50 take a picture of an entire region from the display surface 21 to upper ends of respective side portions 11 to 13 to generate a display surface entire image 500 as shown in FIGS. 3 to 5. A right side portion 11, front side portion (a side at the front) 12 and a left side portion 13 of the body 10 are displayed in the display surface entire image 500. When a pointer is present on the display surface 21, the pointer is displayed at the position corresponding to the position pointed by the pointer. The color camera 50 sends the display surface entire image 500 to the computing unit 70.

The storage 60 stores pointer-associated processing information 600 shown in FIG. 6 and various pieces of information required for the operation of the electronic blackboard device 1. The pointer-associated processing information 600 is updated by the computing unit 70 and the like as necessary. The pointer-associated processing information 600 includes pointer information 601, side shape information 602, side color information 603 and processing detail information 604.

The pointer information 601 includes details for identifying the target pointer R such as the name of the target pointer R.

The side shape information 602 and the side color information 603 respectively include the details of the shape (referred to as side shape) and color (referred to as side color) of the target pointer R seen in a direction substantially parallel to the display surface 21. The side shape included in the side shape information 602 encompasses both a profile and a size of the target pointer. The details of the side shape and side color may encompass a certain range of side shapes and side colors considering a pointing angle, an illumination color and the like.

The processing detail information 604 includes processing details of the computing unit 70 when the display surface 21 is pointed by the target pointer R specified by the pointer information 601.

The computing unit 70 include: a camera initial adjustment value calculator 71; an ambient light detector 72; a pointed position identifier 73; a pointed position image acquirer 74; a pointer identifier 75; and a processing executor 76, all provided by various computer programs.

While no pointer is present on the display surface 21, the camera initial adjustment value calculator 71 performs initial offset processing of the first and second infrared cameras 30 and 40 and the color camera 50.

Specifically, when the initial offset processing for the first infrared camera 30 is performed, the camera initial adjustment value calculator 71 generates infrared rays by the first and second light radiators 31 and 32 and the light reflected by the respective side portions 11 to 13 of the body 10 is received by the first light receiver 33. Then, the camera initial adjustment value calculator 71 calculates a receiving light amount adjusting value that allows a predetermined amount of light of a predetermined color to be received by the first light receiver 33.

Further, when the initial offset processing of the color camera 50 is performed, the camera initial adjustment value calculator 71 takes the display surface entire image 500 of the respective side portions 11 to 13 by the color camera 50 and calculates a color adjustment value for providing a preset amount of light of a predetermined wavelength (a preset intensity of light of a predetermined color) in the display surface entire image 500.

The ambient light detector 72 performs an ambient light check scanning processing while the pointer is not present on the display surface 21.

Specifically, the ambient light detector 72 takes the display surface entire image 500 of the respective side portions 11 to 13 by the color camera 50 and compares the currently-taken display surface entire image 500 and the display surface entire image 500 taken during the initial offset processing of the color camera 50. Then, when the intensity of at least one of colors in the display surface entire images 500 has changed by a predetermined level or more, it is recognized that the light amount and/or color of the light being irradiated over the display surface 21 has changed due to on/off operation of a room illumination and the like and it is judged that ambient light is detected. On the other hand, when the intensity of at least one of the colors has changed by a predetermined level or more, it is judged that ambient light is not detected.

The pointed position identifier 73 performs a pointer check scanning processing after performing the initial offset processing.

Specifically, the pointed position identifier 73 generates infrared rays by the first to fourth light radiators 31, 32, 41 and 42, recognizes a light-receiving state of the first and second light receivers 33 and 43 and adjusts the light-receiving state according to the receiving light amount adjusting value. Incidentally, the light-receiving state of the first and second light receivers 33 and 43 may be adjusted based on the receiving light amount adjusting value and the adjusted light-receiving state may be recognized by the pointed position identifier 73.

Then, when the pointed position identifier 73 recognizes under the adjusted light-receiving state that reflected light of a color other than that of the side portions 11 to 13 is received, the pointed position identifier 73 judges that a pointer is present. Further, using triangulation, the pointed position identifier 73 calculates coordinates P on the display surface 21 on which the pointer is present based on incident angles a and of the reflected light from the pointer on each of the first and the second light receivers 33 and 43.

As shown in FIGS. 3 to 5, the pointed position image acquirer 74 acquires a part of the display surface entire image 500 as the pointed position image 510.

Specifically, the pointed position image acquirer 74 takes the image on the display surface 21 with the color camera 50 to acquire the display surface entire image 500 and acquires information on the pointed position and the side shape of the pointer from the pointed position identifier 73. Then, based on the pointed position and the side shape, the pointed position image acquirer 74 specifies a rectangular region of a minimum size in which the entirety of the pointer in the display surface entire image 500 is included. The region is extracted as the pointed position image 510. For instance, as shown in FIGS. 3, 4 and 5, the rectangular pointed position images 510 of a minimum size respectively containing the entirety of the red pen Rr, the finger Rf and the palm Rp are extracted from the display surface entire image 500.

As discussed above, since a region of a minimum size containing the entirety of the pointer is extracted as the pointed position image 510, a photographic subject (referred to as a largest-area photographic subject hereinafter) that occupies the largest area in the pointed position image 510 is the pointer. It should be understood that the size of the pointed position image 510 may be larger than the width of the pointer and the shape of the pointed position image 510 may be the same as the shape of the pointer.

The pointer identifier 75 recognizes the side color and the nature of the pointer based on the pointed position image 510.

Specifically, the pointer identifier 75 acquires the pointed position image 510 from the pointed position image acquirer 74 and adjusts the color of the pointed position image 510 based on a color adjustment value calculated by the camera initial adjustment value calculator 71. It should be understood that the display surface entire image 500 may be adjusted in the color camera 50 and the pointed position image acquirer 74 based on the color adjustment value.

The pointer identifier 75 calculates a color centroid of the largest-area photographic subject in the pointed position image 510 according to HSV color system and recognizes the color centroid as the side color of the pointer. Further, the pointer identifier 75 calculates the side shape of the pointer seen from the first and second light receivers 33 and 43 based on the state of the reflected light from the pointer received by each of the first and the second light receivers 33 and 43.

The processing executor 76 performs the processing associated with the target pointer R.

Specifically, the processing executor 76 searches the storage 60 for the pointer-associated processing information 600 bearing the side shape information 602 and the side color information 603 including the side shape and the side color calculated by the pointer identifier 75. When the pointer-associated processing information 600 is retrieved, judging that the pointer pointing on the display surface 21 is the target pointer R and is registered in the storage 60, the processing executor 76 performs the processing associated with the processing detail information 604 of the pointer-associated processing information 600.

Incidentally, each time the processing executor 76 recognizes that the display surface 21 is pointed by, for instance, the red pen Rr, the processing executor 76 displays a red point at the pointed position. Accordingly, when the red pen Rr moves on the display surface 21, the red point is consecutively displayed in accordance with the movement to produce a red-line drawn image Tr as a result.

### Operation of Electronic Blackboard Device

Next, an operation of the electronic blackboard device 1 will be described below.

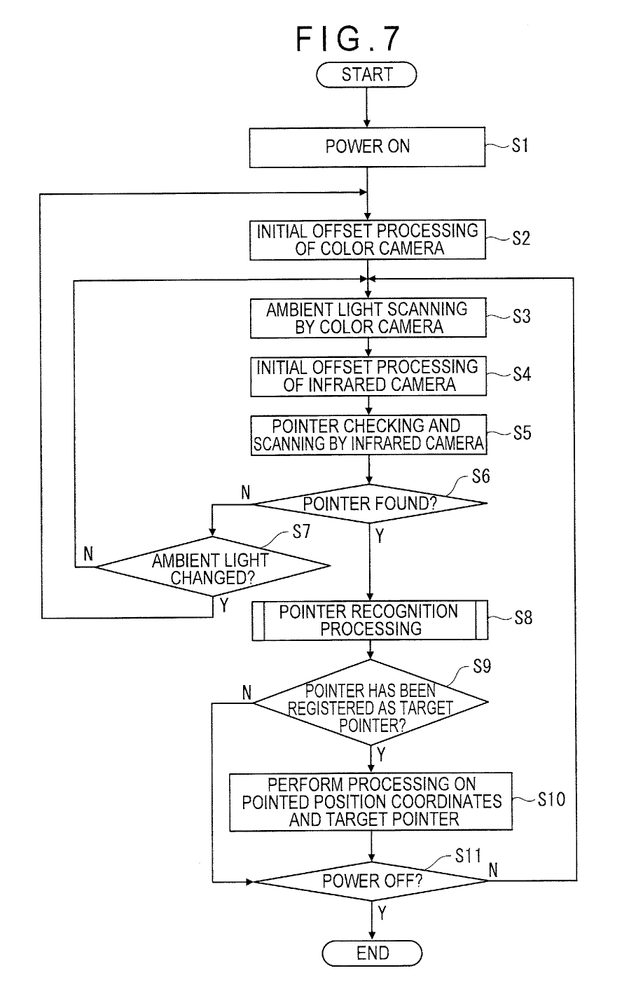

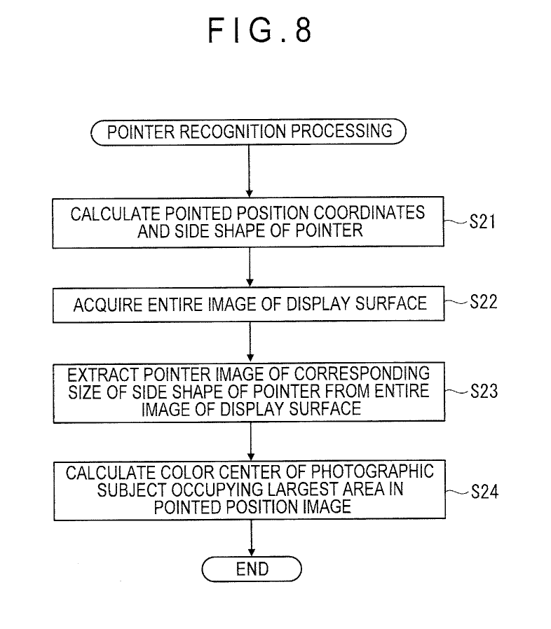

FIG. 7 is a flowchart showing a display processing of the electronic blackboard device. FIG. 8 is a flowchart showing a pointer recognition processing in the display processing.

As shown in FIG. 7, when the camera initial adjustment value calculator 71 recognizes that the power is on (step S1), the computing unit 70 of the electronic blackboard device 1 performs the initial offset processing of the color camera 50 (step S2). Subsequently, the computing unit 70 performs the ambient light check scanning processing (step S3) and the initial offset processing of the first and second infrared cameras 30 and 40 (step S4). Then, the pointed position identifier 73 performs the pointer check scanning processing (step S5) to determine whether a pointer is present on the display surface 21 or not (step S6).

When it is determined in step S6 that no pointer is present, the ambient light detector 72 determines whether a change in the ambient light is detected in the ambient light check scanning processing in step S3 or not (step S7). When it is determined that a change in the ambient light is detected in step S7, the computing unit 70 performs the processing of step S2. When it is determined that a change in the ambient light is not detected, the computing unit 70 performs the processing of step S3.

On the other hand, when it is determined in step S6 that the pointer is present, the computing unit 70 performs a pointer recognition processing (step S8). Though described later in detail, the coordinates P of the pointed position and the side shape and the side color of the pointer are recognized in the pointer recognition processing.

Then, the processing executor 76 judges whether a pointer having the side shape and side color (nature) recognized during the pointer recognition processing is registered in the storage 60 as the target pointer R or not (step S9). In step S9, when the processing executor 76 judges that the pointer is the red pen Rr, green pen Rg, blue pen Rb, finger Rf or palm Rp and is registered in the storage 60 as the target pointer R, the processing executor 76 performs a processing associated with the target pointer R (step S10) and judges whether the electronic blackboard device 1 is powered off or not (step S11). When it is determined in step S11 that the power is off, the processing executor 76 terminates the display processing, When it is determined that the power is not off, the processing executor 76 performs the processing of step S3.

Further, when it is determined in step S9 that the pointer is not registered, the processing executor 76 performs the processing in step S11.

On the other hand, in the pointer recognition processing shown in FIG. 8, the pointed position identifier 73 and the pointer identifier 75 of the computing unit 70 calculates the coordinates of the pointed position and the side shape of the pointer (step S21). Subsequently, the pointed position image acquirer 74 acquires the display surface entire image 500 from the color camera 50 (step S22) and extracts the pointed position image 510 of a size corresponding to the side shape of the pointer from the display surface entire image 500 based on the pointed position identified by the pointed position identifier 73 (step S23). Then, the pointer identifier 75 calculates the color centroid of the largest-area photographic subject in the pointed position image 510 (step S24).

Thereafter, when the processing executor 76 recognizes a drawn image designation request (processing execution request) that requests that only the drawn image Tr of the red pen Rr is displayed while the drawing images Tr, Tg and Tb of the red pen and the like Rr, Rg and Rb are displayed, the processing executor 76 only displays the drawn image Tr and erases the drawn images Tg and Tb.

### Advantages of First Exemplary Embodiment

According to the above electronic blackboard device 1 according to the first exemplary embodiment, the following advantages can be obtained.

(1) The computing unit 70 of the electronic blackboard device 1 calculates the pointed position and the side shape of the pointer on the display surface 21 based on a light-receiving state of the reflected light from the pointer on the first and second infrared cameras 30 and 40. Then, the computing unit 70 acquires the pointed position image 510 that shows the pointed position from the entire display surface 21 and recognizes the color of the pointer by processing the pointed position image 510. Subsequently, the computing unit 70 displays the drawn images Tr, Tg, Tb and Tf of a color corresponding to the pointed position, side shape and color of the pointer and displays only the drawn image Tr of a predetermined color upon receiving the drawn image designation request while displaying the drawn images.

Thus, since the pointed position image 510 showing only a part of (i.e. not the entirety of) the display surface 21 is processed for recognizing the color of the pointer, heavy workload is not applied during the color recognition processing, thus easily improving the processing speed for the pointed position. Further, since the processing speed can be improved without using a computing unit 70 that is adapted to high-speed information processing, an increase in production cost can be restrained. Further, the processing corresponding to the type of the pointer is performed when the pointer is the target pointer R such as the red pen Rr and the processing is not performed when the pointer is a non-target pointer such as a necktie. Thus, a processing in accordance with the intension of the user can be performed. Further, since the user can perform a predetermined processing by only changing the pointer, it is not necessary to conduct complicated operations such as a selection of icon(s) displayed on the display surface 21 for changing the color of the drawn images Tr, Tg, Tb and Tf, thereby enhancing operability of the device. Since only the drawn image Tr can be displayed upon the drawn image designation request, only the predetermined drawn image can be easily recognized.

(2) The computing unit 70 calculates the size of the pointer based on the light-receiving state of the first and second infrared cameras 30 and 40 and acquires the pointed position image 510 of a size corresponding to the calculated size.

Thus, irrespective of the size of the pointer, the largest-area photographic subject in the pointed position image 510 can be determined as the pointer. In other words, the pointer can be identified through a simple process of recognizing the largest-area photographic subject in the pointed position image 510.

(3) The computing unit 70 extracts a part of the display surface entire image 500 that corresponds to the pointed position identified based on the light-receiving state of the first and second infrared cameras 30 and 40 as the pointed position image 510.

Thus, the number of components can be reduced as compared to an arrangement for acquiring the pointed position image 510 using a mechanical control in which, for instance, a camera with a narrower image-taking range than that of the color camera 50 is used and the camera is moved to change the image-taking direction to selectively take the image of the pointed position.

(4) The computing unit 70 calculates the side shape of the pointer based on the light-receiving state of the first and second infrared cameras 30 and 40.

Accordingly, as compared with an arrangement in which the side shape is calculated according to the color of the pixels constituting the display surface entire image 500, the processing workload of the computing unit 70 can be reduced. Further, since the light-receiving state is used for calculation of both of the pointed position and the side shape, the number of components can be reduced as compared with an arrangement using separate mechanisms for calculating the pointed position and the side shape are provided, in which, for instance, the pointed position is calculated using a so-called touch panel and the side shape is calculated based on the light-receiving state.

(5) The computing unit 70 performs the initial offset processing and the ambient light check scanning processing of the color camera 50 prior to the processing for recognizing the pointer color.

Thus, the color of the pointer can be recognized while restraining the influence of the ambient light to the minimum.

(6) The computing unit 70 performs the initial offset processing of the first and second infrared cameras 30 and 40 before performing the pointer check scanning processing.

Thus, even when the light-receiving amount of the first and second light receivers 33 and 43 falls below a predetermined level due to adhesion of dust and the like on the first to fourth light radiators 31, 32, 41 and 42 and the first and second light receivers 33 and 43, appropriate processing can be performed without removing dust and the like by calculating the receiving light amount adjusting value on the basis of the lowered light-receiving amount.

### Second Exemplary Embodiment

Next, a second exemplary embodiment of the invention will be described below.

Arrangement of Electronic Blackboard Device

An electronic blackboard device (display device) 1A shown in FIG. 2 displays, erases, enlarges or contracts the drawn images Tr, Tg, Tb and Tf in accordance with the operation of the red pen Rr, green pen Rg, blue pen Rb, finger Rf and palm Rp.

The electronic blackboard device 1A is arranged in a manner similar to the electronic blackboard device 1 of the first exemplary embodiment except for a processing executor 76A of a computing unit 70A constituting an information processing device 80A. Incidentally, the electronic blackboard device 1A of the second exemplary embodiment is disposed, for instance, on a wall of a classroom so that a display surface 21A of a display 20A is vertically situated.

### Operation of Electronic Blackboard Device

Next, the operation of the electronic blackboard device 1A will be described below.

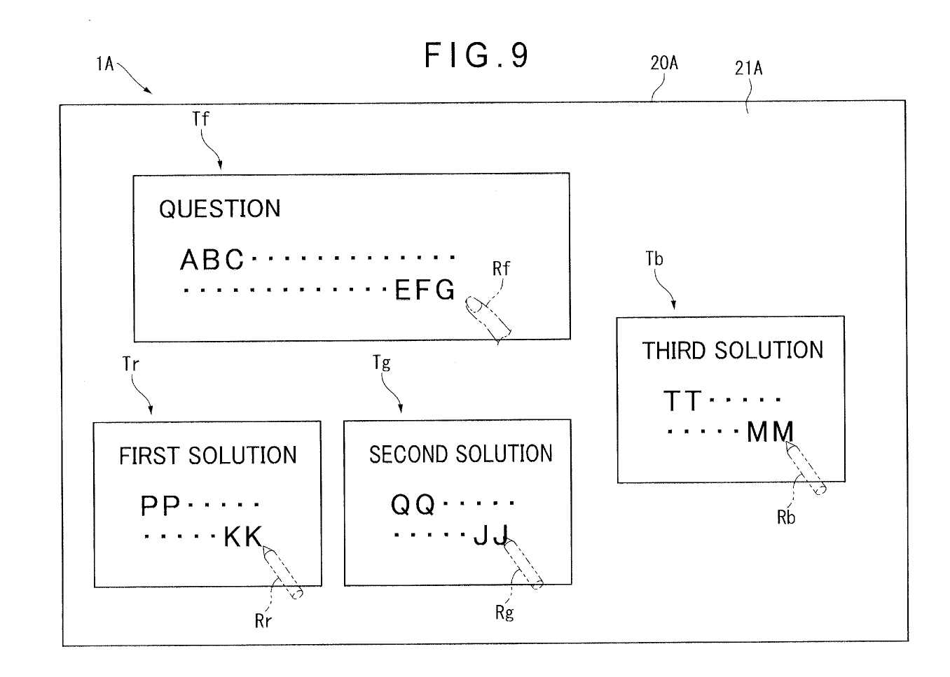

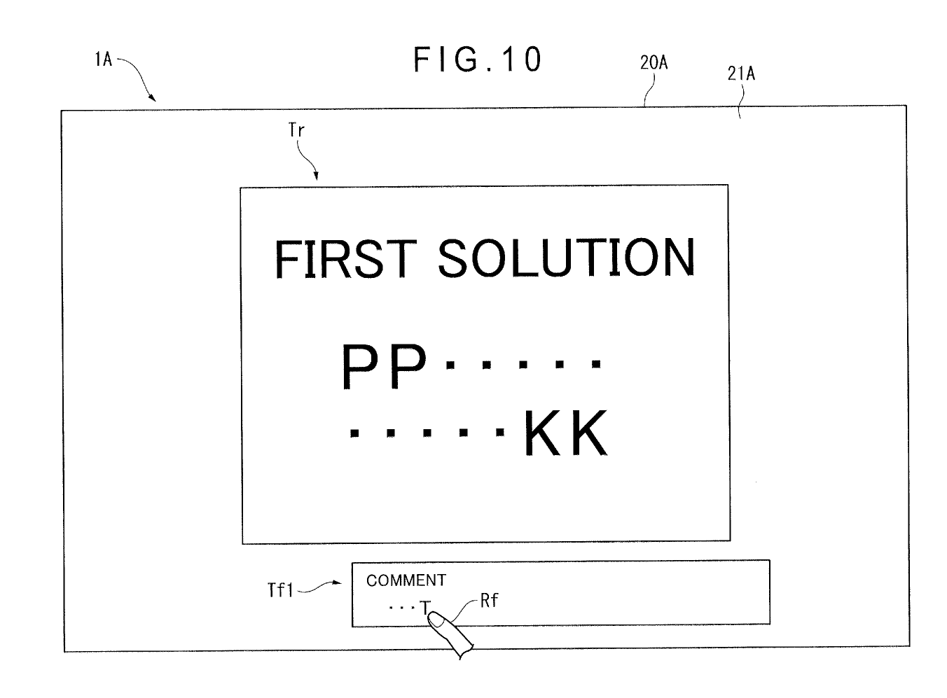

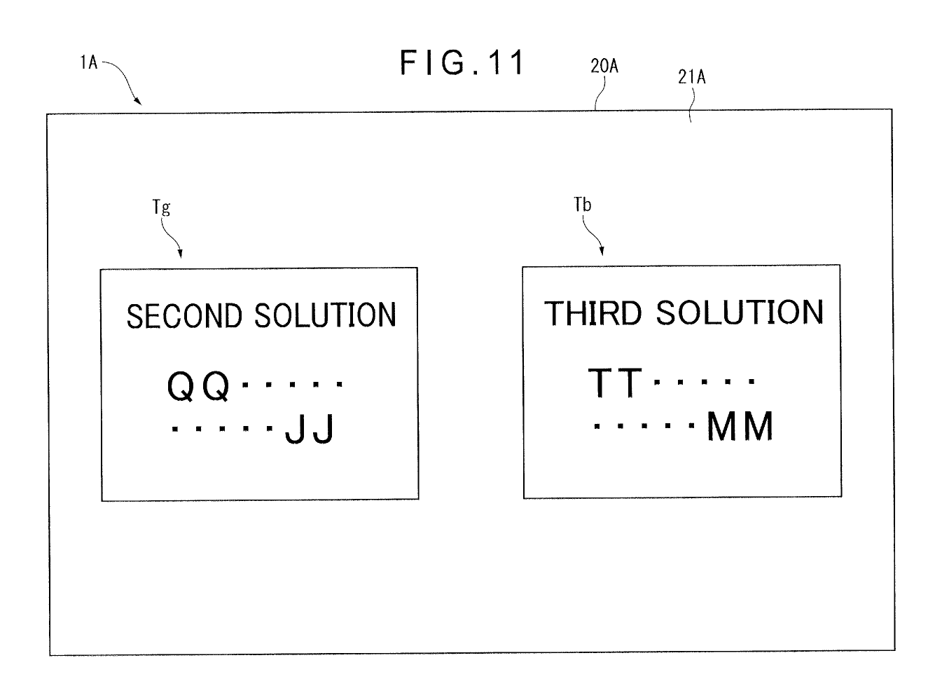

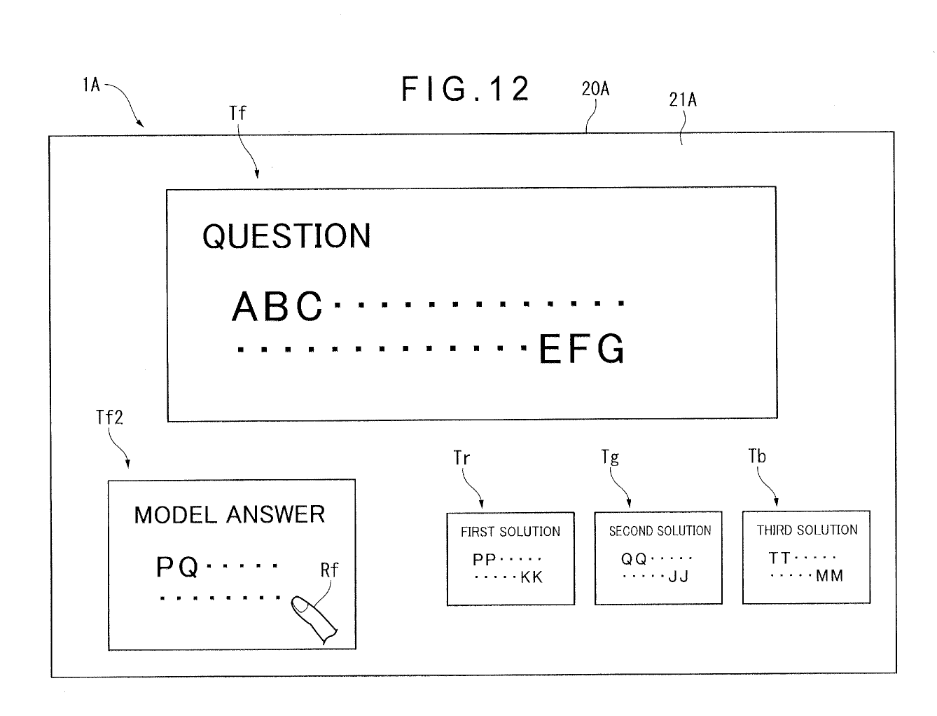

FIG. 9 schematically illustrates a display state after writing completion. FIG. 10 schematically illustrates an enlarged display state of one drawn image. FIG. 11 schematically illustrates an enlarged display state of two drawn images. FIG. 12 schematically illustrates a display state of a model answer.

The computing unit 70A of the electronic blackboard device 1A performs processing similar to the processing in steps S1 to S11 of the electronic blackboard device 1 of the first exemplary embodiment. As shown in FIG. 9, the processing executor 76A displays the drawn images Tr, Tg, Tb and Tf at the position pointed by the red pen Rr, green pen Rg, blue pen Rb and finger Rf (pointed position display processing). Further, the processing executor 76A stores the data of the drawn images Tr, Tg, Tb and Tf in the storage 60.

Incidentally, the drawn image Tf (question TO is a question given by a teacher and the drawn images Tr, Tg and Tb (first, second and third solutions Tr, Tg and Tb) are first, second and third solutions provided by student(s).

Subsequently, when the processing executor 76A recognizes a drawn image designation request for displaying only the first solution Tr in an enlarged manner based on, for instance, an operation for designating the first solution Tr and an operation on an enlarge button (not shown) on the display surface 21A performed by a teacher, the processing executor 76A displays only the first solution Tr in an enlarged manner at the center of the display surface 21A as shown in FIG. 10 (display state changing processing). Specifically, the processing executor 76A detects the center of the first solution Tr by detecting the position of the upper, lower, right and left ends of the first solution Tr before enlargement, and moves and enlarges the first solution Tr so that the center is located at the center of the display surface 21A.

Then, the processing executor 76A displays a drawn image Tf1 (comment Tf1) representing a comment in accordance with a movement of the finger Rf of the teacher and stores the data of the comment Tf1 in the storage 60.

Further, when the processing executor 76A recognizes a partial enlargement request for displaying only the second and third solutions Tg and Tb by the teacher, the processing executor 76A displays the second solution Tg at a center of a left half of the display surface 21A in an enlarged manner and displays the third solution Tb at a center of a right half of the display surface 21A in an enlarged manner as shown in FIG. 11.

Further, when the processing executor 76A recognizes an operation by the teacher for writing a model answer, the processing executor 76A displays the question Tf at a center in the right-left direction of an upper side of the display surface 21 in an enlarged manner and displays the first, second and third solutions Tr, Tg and Tb at a right lower end of the display surface 21A in an reduced manner as shown in FIG. 12. Then, the processing executor 76A displays a drawn image Tf2 (model answer Tf2) representing a model answer in accordance with a movement of the finger Rf of the teacher and stores the data of the model answer Tf2 in the storage 60.

Further, when the processing executor 76A recognizes an operation by the teacher for displaying the first solution Tr in an enlarged manner, the processing executor 76A displays the first solution Tr at a center of the display surface 21A in an enlarged manner and displays the question Tf, the model answer Tf2 and the second and third solutions Tg and Tb at a right lower end of the display surface 21A in an reduced manner.

In addition, when the processing executor 76A recognizes an operation for reviewing lessons in, for instance, the next lesson, the processing executor 76A displays the question Tf, the comment Tf1 and the model answer Tf2 written by the teacher on the display surface 21A as necessary.

### Advantages of Second Exemplary Embodiment

According to the above electronic blackboard device 1A of the second exemplary embodiment, the following advantages can be obtained in addition to the advantages (1) to (6) in the first exemplary embodiment.

(7) When the computing unit 70A recognizes the partial enlargement request that requests that only the first solution Tr is enlarged, the computing unit 70A displays only the first solution Tr in an enlarged manner based on the request. Accordingly, when the teacher gives an explanation on a desired solution, only the solution can be displayed in an enlarged manner so that the students can easily recognize the subject to be explained.

(8) Upon the partial enlargement request, the computing unit 70A displays only the first solution Tr corresponding to the request. Accordingly, the teacher can give more written explanation on the enlarged first solution Tr, so that the efficiency of the lesson and intelligibility of the students can be enhanced.

(9) When the computing unit 70A recognizes an operation for reviewing lessons, the computing unit 70A displays the question Tf, the comment Tf1 and the model answer Tf2 written by the teacher on the display surface 21A during a preceding lesson. Accordingly, the efficiency of the lesson can be improved.

### Third Exemplary Embodiment

Next, a third exemplary embodiment of the invention will be described below.

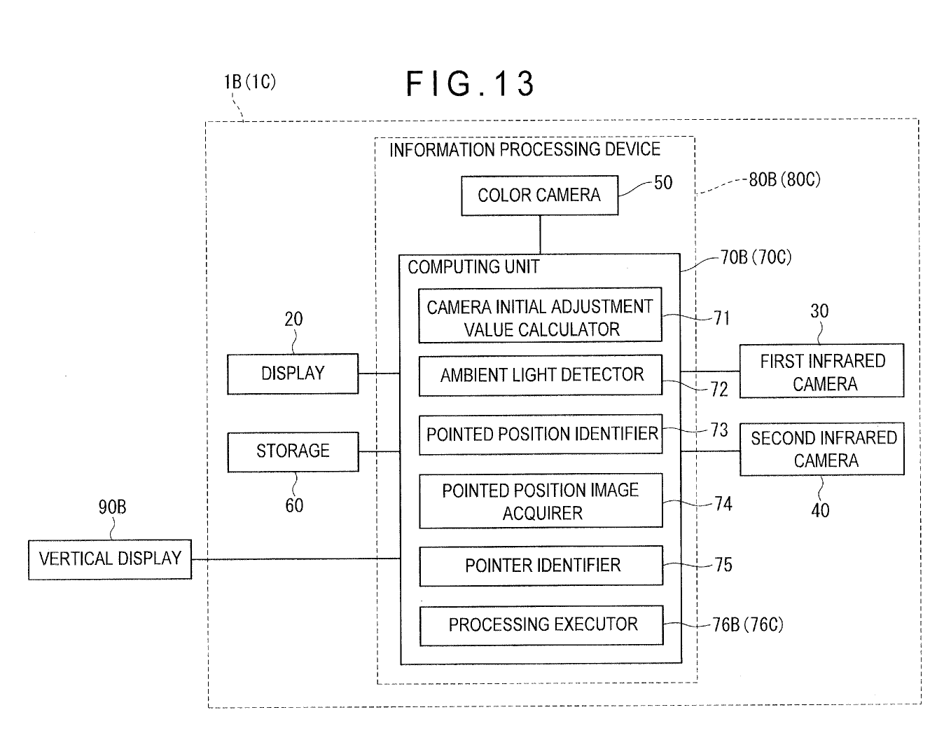

FIG. 13 is a block diagram showing an overall structure of a relevant part of the electronic blackboard device.

Arrangement of Electronic Blackboard Device

An electronic blackboard device (display device) 1B shown in FIG. 13 displays, erases, enlarges or contracts red, green, blue, pink and black drawn images Tr11, Tg11, Tb11, Tm11 and Tf11 in accordance with the operation of the red pen Rr, green pen Rg, blue pen Rb, pink pen Rm, finger Rf and palm Rp.

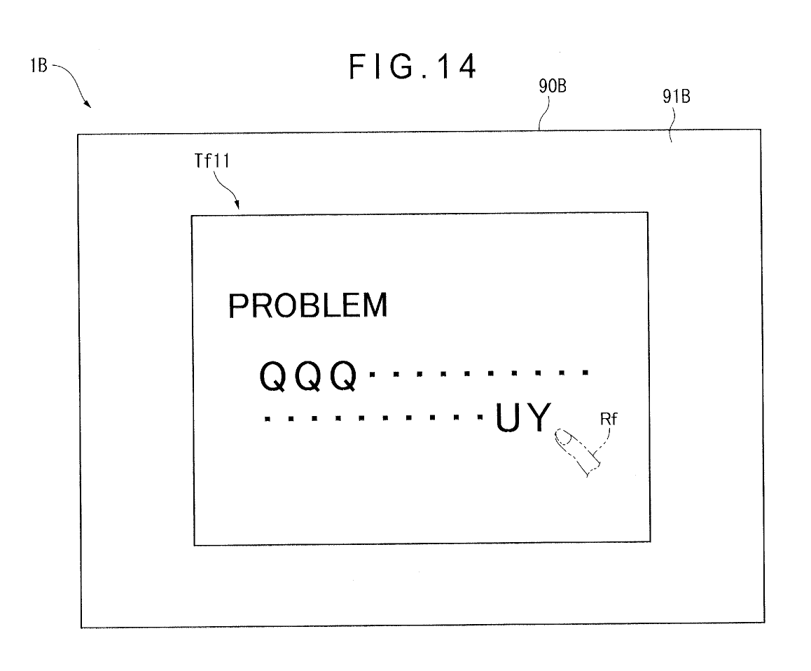

The electronic blackboard device 1B is arranged in a manner similar to the electronic blackboard device 1 of the first exemplary embodiment except for a processing executor 76B of a computing unit 70B constituting an information processing device 80B and a vertical display 90B. Incidentally, the electronic blackboard device 1B of the third exemplary embodiment and an electronic blackboard device 1C of a later-described fourth exemplary embodiment are disposed, for instance, at a center of a classroom so that a display surface 21 of a display 20 is horizontally situated. The vertical display 90B (display of the invention) is provided independently of the body 10 and is provided on a body (not shown) installed on, for instance, a wall of a classroom so that a display surface 91B shown in FIG. 14 is vertically situated.

### Operation of Electronic Blackboard Device

Next, the operation of the electronic blackboard device 1B will be described below.

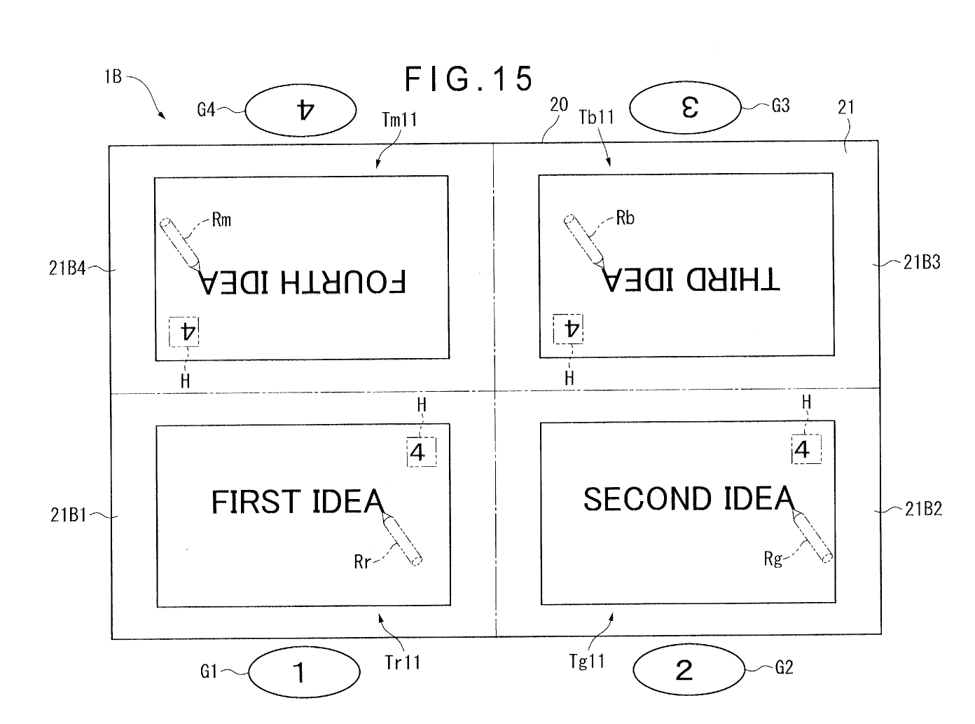

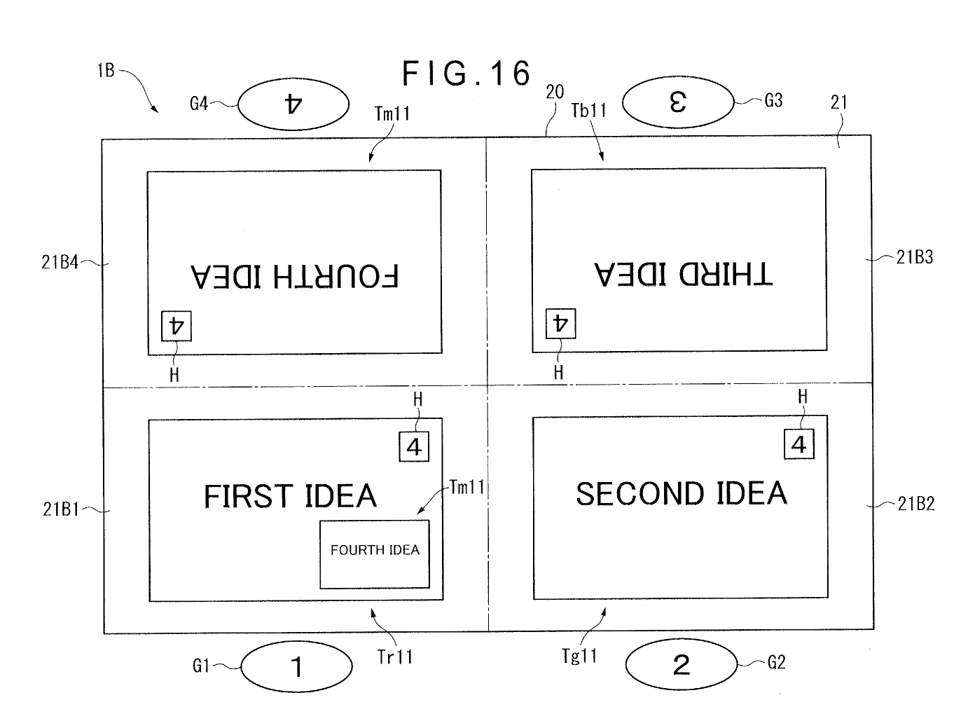

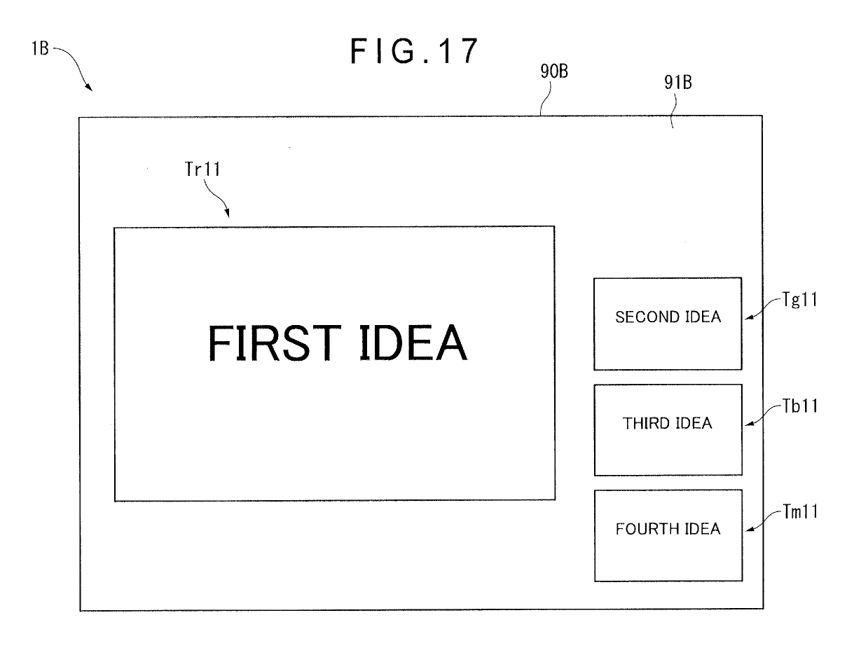

FIG. 14 schematically illustrates a display state after a problem is written on a vertical display. FIG. 15 schematically illustrates a display state after an idea is written on a display. FIG. 16 schematically illustrates a display state of a display when an idea of a fourth student is displayed on a display area of a first student. FIG. 17 schematically illustrates a display state when ideas of the first to fourth students are displayed on the vertical display.

When the computing unit 70B of the electronic blackboard device 1B recognizes a display area designation request for designating a writing position on the display surface 21 for each of the students, the computing unit 70B performs processing similar to the processing in steps 1 to S11 of the electronic blackboard device 1 of the first exemplary embodiment. Then, as shown in FIGS. 14 and 15, the processing executor 76B displays the drawn images Tr11, Tg11, Tb11, Tm11 and Tf11 at the position pointed by the red pen Rr, green pen Rg, blue pen Rb, pink pen Rm and finger Rf (pointed position display processing). Further, the processing executor 76B stores the data of the drawn images Tr11, Tg11, Tb11, Tm11 and Tf11 in the storage 60.

The processing executor 76B bisects the display surface 21 both in the vertical direction and horizontal direction in FIG. 15 (in front-back and right-left directions seen by a first student G1) to define a first display area 21B1, second display area 21B2, third display area 21B3 and fourth display area 21B4. When the first display area 21B1 is pointed by the red pen Rr, the processing executor 76B displays the drawn image Tr11 in the first display area 21B1. On the other hand, when the first display area 21B1 is pointed by the pens Rg, Rb and Rm of the other color or the finger Rf, the processing executor 76B does not display the drawn images Tg11, Tb11 and Tm11 in the first display area 21B1. Similarly, the processing executor 76B displays in each of the second, third and fourth display areas 21B2, 21B3 and 21B4 each of the drawn images Tg11, Tb11 and Tm11 by the green pen Rg, blue pen Rb and pink pen Rm and drawn image by the pen of the other color and the finger Rf is not displayed.

Incidentally, the drawn image Tf11 (problem Tf11) is a problem given by the teacher and the drawn images Tr11, Tg11, Tb11 and Tm11 (first, second, third and fourth ideas Tr11, Tg11, Tb11 and Tm11) are first, second, third and fourth ideas provided by students G1, G2, G3 and G4.

The first and second students G1 and G2 are seated side by side in right and left direction. The third and fourth students G3 and G4 are seated at a position facing the first and second students G1 and G2 across the display 20.

When the processing executor 76B recognizes an operation for displaying the fourth idea Tm11 by the fourth student G4 on the rest of display areas (the first to third display areas 21B1 to 21B3), the processing executor 76B displays an icon H in the first to third display areas 21B1 to 21B3 as shown in FIG. 16. Subsequently, when the processing executor 76B recognizes a selecting operation on the icon H by, for instance, the first student G1, the processing executor 76B displays the fourth idea Tm11 at a right lower end of the first display area 21B1 in a reduced manner.

Further, when the processing executor 76B recognizes that an inside of the display area of the fourth idea Tm11 is pointed with the red pen Rr by the first student G1, the processing executor 76B displays a red drawn image in accordance with the movement of the red pen Rr at the pointed position and stores the data of the fourth idea Tm11 to which the drawn image is added in the storage 60.

Further, when the processing executor 76B recognizes an operation for displaying the fourth idea Tm11 added with the red drawn image in the second to fourth display areas 21B2 to 21B4, the processing executor 76B displays the icon H in the second to fourth display areas 21B2 to 21B4. Subsequently, when the icon H in, for instance, the second display area 21B2 is selected, the processing executor 76B displays the fourth idea Tm11 added with the red drawn image at the right lower end of the second display area 21B2.

Further, when the processing executor 76B recognizes a drawn image designation request by the teacher for displaying the first idea Tr11 on the vertical display 90B in an enlarged manner and displaying the second, third and fourth ideas Tg11, Tb11 and Tm11 in a reduced manner, the processing executor 76B displays these items on the display surface 91B as shown in FIG. 17 (display state changing processing).

When it is recognized that an inside of the display area of the first idea Tr11 is pointed with the finger Rf by the teacher, the processing executor 76B displays a black drawn image at the pointed position and stores the data of the first idea Tr11 to which the drawn image is added in the storage 60.

### Advantages of Third Exemplary Embodiment

According to the above electronic blackboard device 1B according to the third exemplary embodiment, the following advantage can be obtained in addition to the advantages (1) to (7) and (9) in the first and second exemplary embodiments.

(10) The computing unit 70B displays the drawn images in each of the first to fourth display areas 21B1 to 21B4 in accordance with the pointing solely by one of the red pen Rr, green pen Rg, blue pen Rb and pink pen Rm. Accordingly, unintended addition of the drawn image to, for instance, the first display area 21B1 can be avoided.

### Fourth Exemplary Embodiment

Next, a fourth exemplary embodiment of the invention will be described below.

### Arrangement of Electronic Blackboard Device

An electronic blackboard device (display device) 1C shown in FIG. 13 displays, erases, enlarges or contracts red, green, blue, pink and black drawn images Tr21, Tr22 and Tg21 in a manner similar to the electronic blackboard device 1B in the second exemplary embodiment.

The electronic blackboard device 1C is arranged in a manner similar to the electronic blackboard device 1B of the third exemplary embodiment except for a processing executor 76C of a computing unit 70C constituting an information processing device 80C.

### Operation of Electronic Blackboard Device

Next, the operation of the electronic blackboard device 1C will be described below.

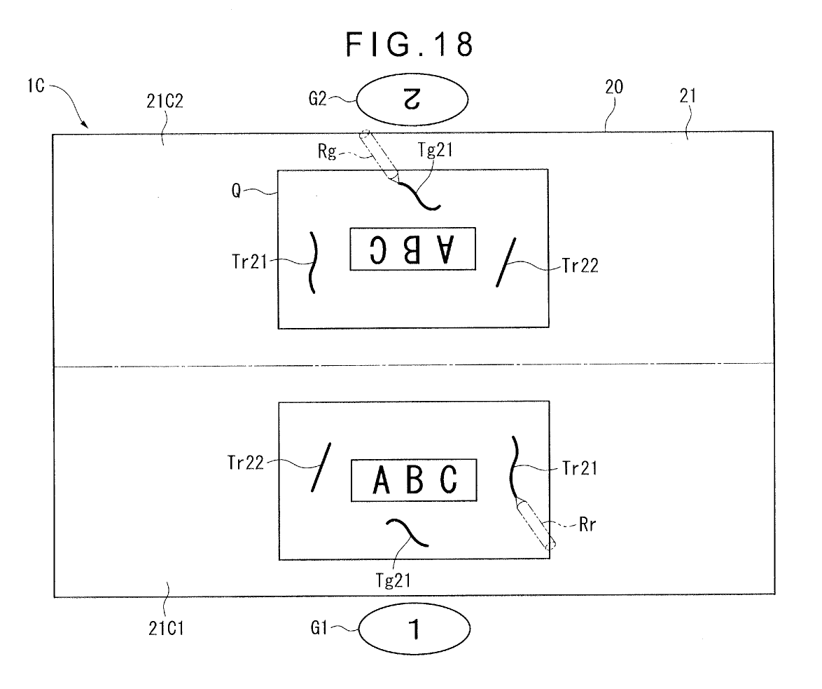

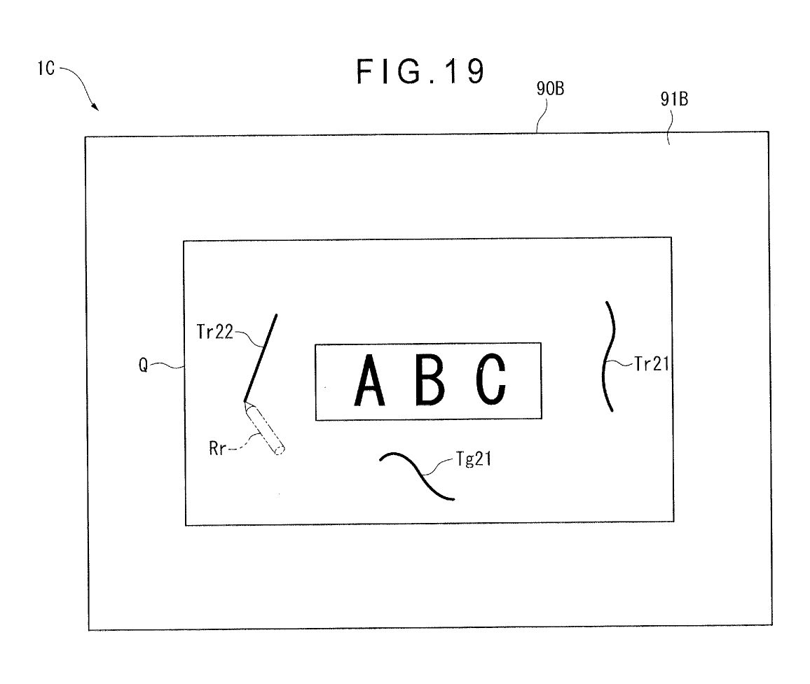

FIG. 18 schematically illustrates a display state during writing process on a display. FIG. 19 schematically illustrates a display state during writing process on a vertical display.

Initially, the computing unit 70C of the electronic blackboard device 1C performs processing similar to the processing in steps Si to S11 of the electronic blackboard device 1 of the first exemplary embodiment. Further, when the processing executor 76C recognizes an operation for displaying an original image Q stored in the storage 60 at two sections on the display 20 and one section on the vertical display 90B, the processing executor 76C displays the original image Q as shown in FIGS. 18 and 19.

The processing executor 76C bisects the display surface 21 in FIG. 18 (in front-back directions seen by the first student G1) to define the first display area 21C1 and second display area 21C2.

Incidentally, the first student G1 is seated at a position facing the second student G2.

The original image Q may be a drawn image previously produced by the first student G1, the second student G2 or the teacher or may be an image of a landscape and the like pictured by an imaging device.

In a drawing mode, when an inside or an outside of the original image Q in the first display area 21C1 is pointed by the red pen Rr, the processing executor 76C displays the drawn image Tr21 at the pointed position in the first display area 21C1 (pointed position display processing) and stores the data of the drawn image Tr21 in the storage 60. Further, the original image Q and the drawn image Tr21 are displayed also on the second display area 21C2 and the display surface 91B in the same display state as in the first display area 21C1.

When the drawn image Tr21 is pointed by the red pen Rr in an erase mode, the processing executor 76C erases a portion of the pointed position corresponding to the pointed position in the drawn image Tr21 and updates the data in the storage 60. Further, the processing executor 76C also erases the drawn image Tr21 in the second display area 21C2 and the display surface 91B.

Even when the first display area 21C1 is pointed by a pointer other than the red pen Rr such as the green pen Rg, the processing executor 76C does not display a drawn image on the first and second display areas 21C1 and 21C2 and the display surface 91B.

Further, even when the drawn image Tr21 in the first display area 21C1 is pointed by a pointer other than the red pen Rr in the erase mode, the processing executor 76C does not erase the drawn image Tr21 on the first and second display areas 21C1 and 21C2 and the display surface 91B.

In other words, the processing executor 76C displays the drawn image Tr21 or erases at least a part of the displayed drawn image Tr21 in the first and second display areas 21C1 and 21C2 and the display surface 91B only when the first display area 21C1 is pointed with the red pen Rr.

Further, the processing executor 76C displays the drawn image Tg21 or erases at least a part of the displayed drawn image Tg21 in the first and second display areas 21C1 and 21C2 and the display surface 91B only when the second display area 21C2 is pointed with the green pen Rg.

In addition, the processing executor 76C displays the drawn images Tr21, Tr22 or Tg21 or erases at least a part of the displayed drawn images Tr21, Tr22 or Tg21 in the first and second display areas 21C1 and 21C2 and the display surface 91B only when the display surface 91B is pointed with the red pen Rr or the green pen Rg. The processing executor 76C also updates the data in the storage 60 as necessary.

### Advantages of Fourth Exemplary Embodiment

According to the above electronic blackboard device 1C of the second exemplary embodiment, the following advantage can be obtained in addition to the advantages (1) to (6) in the first exemplary embodiment.

(11) The computing unit 70C displays the drawn image(s) displayed when one of the first and second display areas 21C1 and 21C2 and the display surface 91B on the rest of the first and second display areas 21C1 and 21C2 and the display surface 91B. Accordingly, the information can be shared between the users of the first and second display areas 21C1 and 21C2 and the display surface 91B.

### Modification(s)

It should be understood that the scope of the present invention is not limited to the above-described exemplary embodiments but includes modifications and improvements as long as the modifications and improvements are compatible with the invention.

Specifically, the following arrangement may be used for identifying the pointed position of the pointer.

Initially, the pointed position may be identified according to reflection of wireless medium (light, sound) emitted toward the pointer. In this case, since the position of the pointer in the depth direction cannot be calculated with only one receiver (e.g. a camera) that receives the wireless medium, a plurality of receivers may be preferably employed.

Further, the pointed position may be identified based on the time until the wireless medium returns after being reflected by the pointer using a TOF (Time-Of-Flight) method.

Further, the pointed position may be identified based on the contact between the pointer and the display surface using an electrostatic capacitance method or resistive method.

The following arrangement may be used for identifying the pointer.

The pointer may be identified with the use of an imaging device based on at least one of color, shape and size of the pointer. For instance, the pointer may be identified by detecting the (color,) shape and size of the pointer at a position spaced apart from the display surface by a predetermined distance. Incidentally, in order to enhance the detection accuracy of the pointed position, it is preferable that the pointer and the display surface are in point contact with each other.

The shape or size of the pointer may be identified based on a pattern observed when the wireless medium returns after being reflected by the pointer using a TOF (Time-Of-Flight) method. At this time, since the pointer and the display surface are contacted substantially at a point, the shape and the like can be appropriately identified using a reflection pattern of the pointer at a position near (e.g. a position spaced apart from the display surface by several millimeters) the display surface.

Further, the color, shape and size of the pointer may be identified using a camera provided for identifying the pointed position.

Further, a monochrome camera may be used instead of the color camera 50, where the color of the pointer is not considered for identifying the pointer.

Only the pointed position is recognized based on the light-receiving state of the first and second infrared cameras 30 and 40 and the pointed position image 510 of identical size is extracted from the display surface entire image 500 irrespective of the size of the pointer. Then, based on the pointed position image 510, at least one of the shape, size and color of the pointer is recognized as the nature of the pointer and the processing associated with the nature and the pointed position may be performed.

Then, after recognizing a series of the movement of the pointer based on the plurality of pointed positions identified by the pointed position identifier 73, the processing associated with the series of the movement may be performed. For instance, a red point is displayed each time the pointed position of the red pen Rr is recognized and a red line is displayed by consecutively displaying the red point in the above exemplary embodiment. However, a red line corresponding to a series of the movements may be drawn after recognizing the series of the movements of the red pen Rr.

Further, different processing may be performed in accordance with the pointer pointing to a specific point on the display surface 21.

The initial offset processing of the color camera 50 and first and second infrared cameras 30 and 40 may not be performed. The ambient light check scanning processing may not be performed, either.

Further, regardless of the size of the pointer, the pointed position image 510 of the same size may be extracted from the display surface entire image 500. Though a camera of an image-taking range narrower than that of the color camera 50 may be used and the image-taking direction may be changed by moving the camera according to the pointed position identified by the pointed position identifier 73, so that the pointed position image 510 in which only the image of the pointed position is taken can be acquired.

Further, though the drawn image corresponding to the movement of the pointer R is displayed in the exemplary embodiments, a pointer-associated image that is preset for the pointer R may be displayed at the pointed position of the pointer R. For instance, a red circle may be displayed at the position pointed by the red pen Rr regardless of the movement of the red pen Rr. Though the line of a color corresponding to the red pen Rr, green pen Rg, blue pen Rb and finger Rf is displayed, a line of a width or a line type corresponding to the red pen Rr, green pen Rg, blue pen Rb and finger Rf may alternatively be displayed. For instance, a black solid line may be displayed when being pointed by the red pen Rr and a black dotted line may be displayed when being pointed by the green pen Rg.

The display device of the present invention may be used for a portable or desktop personal computer, a portable terminal such as a mobile phone and a PDA (Personal Digital Assistant), a display device for business information and in-vehicle or in-train information and an operating device for electronics, a navigation device and the like.

Though the above-described functions are provided by a computer program, the invention may be embodied as hardware such as a circuit board and a device such as an IC (Integrated Circuit). Incidentally, by embodying the invention as a computer program and by reading the program from an independent recording medium, the invention can be easily applied and can be easily used in a wide range.

The specific arrangements and procedures in actually applying the invention may be altered as necessary as long as the arrangements and procedures are compatible with the invention.

### Advantageous Effect of Embodiment(s)

As described above, the electronic blackboard device 1 calculates the pointed position and the side shape of the pointer on the display surface 21 based on a light-receiving state of the reflected light from the pointer at the first and second infrared cameras 30 and 40, and acquires the pointed position image 510 in which the pointed position is taken from the entire display surface 21. The color of the pointer is recognized by processing the pointed position image 510. Then, the drawn images Tr, Tg, Tb and Tf of colors corresponding to the pointed position, side shape and color of the pointer are displayed and displays only the drawn image Tr of a predetermined color is displayed upon receiving the drawn image designation request while displaying the drawn images.

Thus, since only the drawn image Tr can be displayed upon the drawn image designation request while displaying the drawn images Tr, Tg, Tb and/or Tf, only the predetermined drawn image can be easily recognized.

### INDUSTRIAL APPLICABILITY

The present invention is applicable as an information processing device and an information processing method.

### EXPLANATION OF CODES

20, 20A . . . display
21, 21A . . . display surface
70,70A,70B,70C . . . computing unit
73 . . . pointed position identifier
75 . . . pointer identifier
76,76A,76B,76C . . . processing executor
80,80A,80B,80C . . . information processing device
90B . . . vertical display

1. An information processing device that, when a predetermined position on a display surface of a display is pointed by a pointer, performs a processing corresponding to a pointed position, the information processing device comprising:
a pointed position identifier that identifies the pointed position by the pointer based on a reflection state of a wireless medium emitted toward the pointer or a contact state between the pointer and the display surface;
a pointed position image acquirer that acquires, based on a result of identification of the pointed position by the pointed position identifier, a pointed position image in which the pointed position is taken from an area corresponding to an entirety of the display surface;
a pointer identifier that processes the pointed position image and identifies at least one of a color, a shape and a size of the pointer as a nature of the pointer; and
a processing executor that performs a processing corresponding to the pointed position and the nature of the pointer, wherein
when recognizing that a pointer processing information corresponding to the nature recognized by the pointer identifier is stored in a pointer processing information storage that stores the pointer processing information relating to the processing corresponding to the nature of the pointer, the processing executor performs a drawn-object displaying processing based on the pointer processing information, in which a line of a display format of at least one of a color, a width and a line type corresponding to a movement of the pointer bearing the nature and corresponding to the pointer or a pointer-corresponding image corresponding to the pointer is displayed on the display as a drawn object, and
when recognizing that the pointer processing information corresponding to the nature recognized by the pointer identifier is not stored in the pointer processing information storage, the processing executor does not perform the drawn-object displaying processing.

2. The information processing device according to claim 1, wherein
the drawn-object displaying processing comprises:
a pointed position displaying processing for displaying the drawn object at the pointed position; and
a display-state changing processing in which, based on a pointer designation request that designates a predetermined pointer, a display state of the drawn object pointed by the pointer designated by the pointer designation request is displayed in a manner different from a display state of the drawn object pointed by the pointer not designated by the pointer designation request.

3. The information processing device according to claim 2, wherein
the display-state changing processing is a processing in which the drawn object corresponding to one of the designated pointer and the non-designated pointer is displayed and the drawn object corresponding to the other of the designated pointer and the non-designated pointer is not displayed.

4. The information processing device according to claim 3, wherein
the display-state changing processing is a processing in which the drawn object to be displayed is displayed in an enlarged or reduced manner.

5. The information processing device according to claim 2, wherein
the display-state changing processing is a processing in which the drawn object corresponding to one of the designated pointer and the non-designated pointer is displayed in an enlarged manner and the drawn object corresponding to the other of the designated pointer and the non-designated pointer is displayed in a reduced manner.

6. The information processing device according to claim 3, wherein
the display-state changing processing is a processing in which the drawn object to be displayed is redisplayed in a preset area on the display.

7. The information processing device according to claim 2, wherein
the pointed position displaying processing is a processing in which, in accordance with the processing execution request for displaying only the drawn object corresponding to mutually different one of the pointers in a plurality of display areas defined by dividing the display surface, only the drawn object corresponding to each of the plurality of display areas is displayed in each of the plurality of display areas.

8. The information processing device according to claim 1, wherein
the drawn-object displaying processing is a processing in which, when one of the plurality of display areas defined by dividing the display surface is pointed by the pointer, the drawn object is displayed in all of the plurality of display areas.

9. The information processing device according to claim 1, wherein
after the processing executor recognizes the movement of the pointer identified based on a plurality of the pointed positions, the processing executor performs a processing associated with the movement.

10. A display device comprising:
a display including a display surface; and
an information processing device according to claim 1, the information processing device performing, when a predetermined position on the display surface of the display is pointed by a pointer, a processing corresponding to the pointed position.

11. An information processing method in which, when a predetermined position on a display surface of a display is pointed by a pointer, a processing corresponding to a pointed position is performed, the information processing method being performed by a computing unit and comprising:
identifying a pointed state in which the pointed position by the pointer is identified based on a reflection state of a wireless medium emitted toward the pointer or a contact state between the pointer and the display surface;
acquiring a pointed position image in which, based on a result of identification of the pointed position in the identifying of the pointed state, a pointed position image in which the pointed position is taken from an area corresponding to an entirety of the display surface;
identifying the pointer in which the pointed position image is processed and at least one of a color, a shape and a size of the pointer is recognized as a nature of the pointer; and
executing a processing in which a processing corresponding to the pointed position and the nature of the pointer is executed, wherein
in the executing of the processing,
when recognizing that a pointer processing information corresponding to the nature recognized in the identifying of the pointer is stored in a pointer processing information storage that stores the pointer processing information relating to the processing corresponding to the nature of the pointer, based on the pointer processing information, a drawn-object displaying processing in which a line of at least one of a display format of a color, a width and a line type corresponding to a movement of the pointer bearing the nature and corresponding to the pointer or a pointer-corresponding image corresponding to the pointer is displayed on the display as a drawn object is performed, and
when recognizing that the pointer processing information corresponding to the nature recognized in the identifying of the pointer is not stored in the pointer processing information storage, the drawn-object displaying processing is not performed.
